(19) United States
(12) Patent Application Publication
(10) Pub. No.: US 2009/0228596 A1
(43) Pub. Date: Sep. 10, 2009

(54) METHOD, SERVER AND TERMINAL FOR IMPLEMENTING CALL DIRECTIONS

(75) Inventors: Jian Yang, Shenzhen (CN); Guoqiao Chen, Shenzhen (CN); Lei Wang, Shenzhen (CN); Ting Dong, Shenzhen (CN); Huiping Zhang, Shenzhen (CN); Shunan Fan, Shenzhen (CN); Zheng Wang, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: Huawei Technologies Co., Ltd., Shenzhen (CN)

(21) Appl. No.: 12/471,644

(22) Filed: May 26, 2009

Related U.S. Application Data
(63) Continuation of application No. PCT/CN2008/071973, filed on Aug. 13, 2008.

(30) Foreign Application Priority Data
Aug. 14, 2007 (CN) 200710076510.7

(51) Int. Cl. G06F 15/16; H04L 12/66

(52) U.S. Cl. 709/228; 370/352

(57) ABSTRACT

A method, a server, and a terminal for implementing call directions are provided. The method includes sending a message including PUSH contents to a terminal, receiving a redirection request from the terminal and sending the message according to the redirection request. A server and a terminal or implementing call directions are also provided. When one of the terminals of a subscriber receives a service not supported by the terminal or through the configuration of the subscriber, messages sent from the server are permanently or temporally transferred to other terminals.

### CROSS-REFERENCE TO RELATED APPLICATIONS

The application is a continuation of International Patent Application No. PCT/CN2008/071973, filed Aug. 13, 2008, which claims priority to Chinese Patent Application No. 200710076510.7, filed Aug. 14, 2007, both of which are hereby incorporated by reference in their entirety.

### FIELD OF THE INVENTION

The present invention relates to the field of a wireless communication system, and more particularly to a method, a server, and a terminal for implementing call direction.

### BACKGROUND

A session initiation protocol (SIP) is a control (signaling) protocol of an application layer, and is used to establish, modify, and terminate calls between Internet protocol (IP) (an interconnection protocol between networks) based subscribers. The SIP protocol is a part of an Internet multimedia frame structure, which may be used together with mature Internet protocols in the conventional art. The SIP protocol is used to position a terminal, contact with one terminal to determine the feasibility of establishing a session with the terminal, establish a session between the terminals to exchange media information, and modify/terminate existing media sessions, etc.

As a content distribution mechanism, PUSH adopts a working manner in a client/server mode, and requires the server to distribute the required content without a detailed request from the client. PUSH is initiated by the server, and allows a PUSH initiator (PI) (PUSH message generator) to push information and transmit instructions to a PUSH proxy gateway (PPG), and further transmit the PUSH content to the subscribers.

For a SIP PUSH service, the PUSH content, for example, PUSH over the air (OTA) content, is encapsulated in a SIP message and transported via an existing SIP/IP core network. Referring to FIG. 1, it is a schematic structural view of a system, in which network entities of a register server, a PUSH agent, a SIP/IP core network, and a client are included.

The register server is a server adapted to accept a register request in a SIP network and provide a terminal positioning service.

The PUSH agent is one network unit, capable of transporting service information based on the SIP, which is adapted to receive service information from an IP network or other networks, and transmit the service information based on the SIP after carrying the service information in the SIP message.

The SIP/IP core network represents the SIP network and all the network units on the SIP network.

The client represents terminal equipment, which may be a terminal on a fixed communication network or a terminal on a mobile communication network.

A critical flow of the solution includes the steps as follows: (1) the PUSH agent sends PUSH information to the client through a SIP Message; and (2) the client returns a response message of receiving the PUSH information.

During the process of realizing the present invention, the inventors find that at least the following problems exist in the conventional art. In the conventional art, no call transfer method is provided. For example, one subscriber owns a plurality of terminals, and address information of each terminal is saved on the server. When the server sends a multimedia message to one of the subscriber's terminals through the SIP/IP core network, since the terminal of the subscriber may not support such a service and fails to show the service that reaches the terminal, the subscriber cannot figure out the received information content, thereby effecting subscriber's experience. What is worse, if the server is set to send the multimedia message to each terminal of the subscriber, a network transmission load is increased, thereby wasting the resources.

### SUMMARY

Various embodiments of the present invention provide a method, a server, and a terminal for implementing call direction, so as to solve a redirection problem of a SIP PUSH service in the conventional art, that is, when one of the terminals of a subscriber receives a service not supported by the terminal or through configuration of the subscriber, messages sent from a server are permanently or temporally transferred to other terminals.

An embodiment of the present invention provides a method for implementing call direction, which includes the steps as follows. A PUSH message is sent to a terminal. A redirection request from the terminal is received. The PUSH message is sent according to the redirection request.

An embodiment of the present invention also provides a method for implementing call direction, which includes the steps as follows. A server receives a subscription request from a first terminal, and the subscription request carries address information of a second terminal; and when the server needs to send a PUSH message to the first terminal, the server sends the PUSH message to the second terminal according to the address information.

An embodiment of the present invention further provides a server for implementing call direction, which includes a message sending unit, a subscription request processing unit, and an address storage unit. The message sending unit is adapted to send a PUSH message through a SIP/Internet protocol (IP) core network. The subscription request processing unit is adapted to receive a redirection subscription request from a terminal, and parse the address information of a redirection terminal from the subscription request. The address storage unit is adapted to store the address information of the redirection terminal. When the server needs to send the PUSH message to the terminal, the message sending unit sends the message according to the address information of the redirection terminal.

An embodiment of the present invention further provides a server for implementing call direction, which includes a message sending unit, a redirection request processing unit, and an address unit. The message sending unit is adapted to send a PUSH message through a SIP/Internet protocol (IP) core network. The redirection request processing unit is adapted to receive and parse the redirection request, and determine whether the redirection request carries address information of other terminals or not. The address unit is adapted to obtain the address information of the corresponding redirection terminal according to a parsing result. The message sending unit sends the PUSH message according to the address information of the redirection terminal.

An embodiment of the present invention further provides a terminal for implementing call direction, which includes a redirection address unit, a redirection request setting unit and a redirection request sending unit. The redirection address unit is adapted to store address information of a redirection terminal. The redirection request setting unit is adapted to set a redirection request, in which the redirection request carries address information of the redirection terminal. The redirection request sending unit is adapted to send the redirection request, which is sent through a SIP/Internet protocol (IP) core network.

An embodiment of the present invention further provides a terminal for implementing call direction, which includes a subscription request setting unit and a subscription request sending unit. The subscription request setting unit is adapted to generate a subscription request according to address information of a redirection terminal set by a subscriber. The subscription request sending unit is adapted to send the subscription request, which is sent through a SIP/Internet protocol (IP) core network.

As compared with the conventional art, the present invention has the advantages as follows.

In the embodiments of the present invention, a subscriber has a plurality of terminals. When one of the terminals receives a service not supported by the terminal or through the configuration of the subscriber, the service can be permanently or temporally transferred to other terminals of the subscriber. In the embodiments of the present invention, the subscriber is enabled to select the terminal for receiving the service, thereby enhancing the subscriber's experience, and avoiding the wastes of network resources.

### BRIEF DESCRIPTION OF THE DRAWINGS

FIG. 1 a schematic structural view of a SIP-based PUSH information system;

FIG. 2 is a schematic structural view of a system for implementing call direction according to a first embodiment of the present invention;

FIG. 3 is a schematic structural view of a terminal for implementing call direction according to the first embodiment of the present invention;

FIG. 4 is a signaling flow chart of a method for implementing call direction according to the first embodiment of the present invention;

FIG. 5 is a schematic structural view of a system for implementing call direction according to a second embodiment of the present invention;

FIG. 6 is a schematic structural view of the terminal for implementing call direction according to the second embodiment of the present invention;

FIG. 7 is a signaling flow chart of a method for implementing call direction according to the second embodiment of the present invention;

FIG. 8 is a first signaling flow chart of a method for implementing call direction according to a third embodiment of the present invention;

FIG. 9 is a second signaling flow chart of the method for implementing call direction according to the third embodiment of the present invention; and

FIG. 10 is a signaling flow chart of a method for implementing call direction according to a fourth embodiment of the present invention.

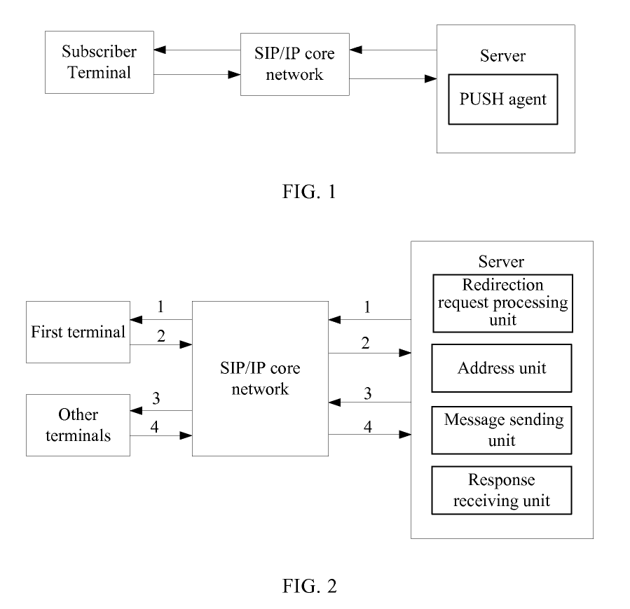

### DETAILED DESCRIPTION OF THE EMBODIMENTS

Embodiments of the present invention provide a method, a system, a server, and a terminal for implementing call direction. Before the call direction is realized, a subscriber has more than one terminal, and address information of all the terminals is registered in a core network and is delivered to a server.

FIG. 2 is a schematic structural view of a system for implementing call direction according to a first embodiment of the present invention. Referring to FIG. 2, the system for implementing call direction includes a SIP/IP core network and a server. The SIP/IP core network is used for the transport of a SIP message, and the SIP message may include PUSH content, for example, PUSH OTA content. The server is adapted to transmit/receive messages through the SIP/IP core network, so as to communicate with a first terminal and other terminals.

The server is further adapted to receive a redirection request from a terminal, and send the message to a corresponding terminal according to the redirection request.

In the embodiment of the system of the present invention, the server and the terminal may realize call redirection in the following manner.

(1) The server sends a PUSH message, for example, Message/Notify message, to the first terminal through the SIP/IP core network.

(2) If the subscriber of the first terminal expects other terminals to receive the message, the first terminal may return a redirection request. The redirection request carries a redirection address, and may further carry a redirection state code for determining a redirection time limit. For example, the redirection state code represents a permanent redirection or a temporal redirection to other terminals, for instance, a redirection state code 301 represents a permanent redirection to other terminals, and a redirection state code 302 represents a temporal redirection to other terminals. Furthermore, the address of other terminals may be carried in a Contact Header field, so as notify the server that the expected redirection address is u2@example.com.

(3) After receiving the redirection request, the server sends the Message/Notify message again through the SIP/IP core network, and the address is changed to the address of other terminals.

(4) After receiving the PUSH message, other terminals return 200 OK messages, and perform a normal process.

Referring to FIG. 2, in an embodiment of a server for implementing call direction of the present invention, the server includes a redirection request processing unit, and a message sending unit. The redirection request processing unit is adapted to receive and parse the redirection request, and determine whether the redirection request carries the address information of other terminals or not. The message sending unit is adapted to send a message through the SIP/IP core network. The server may further include an address information extracting unit and a response receiving unit. The address information extracting unit is adapted to extract the address information from the redirection request. The response receiving unit is adapted to receive and send a response through the SIP/IP core network.

The message sending unit of the server sends a message to a first terminal through the SIP/IP core network, and if the first terminal does not support the service, the first terminal sends a redirection request to the server when receiving the message. The redirection request processing unit of the server receives the redirection request returned by the first terminal through the SIP/IP core network, and then parses the redirection request, and determines whether the redirection request carries address information of other terminals or not. An address unit is adapted to obtain the address information according to a parsing result of the redirection request.

The address unit may further include an address information extracting unit and an address information storage unit. If the redirection request carries the address information of other terminals, the address information extracting unit is triggered to extract the address information from the redirection request, and then the message sending unit of the server sends the message according to the address information. If the redirection request does not carry the address information, pre-stored address information is obtained from the address information storage unit, and then the message sending unit of the server sends the message according to the address information.

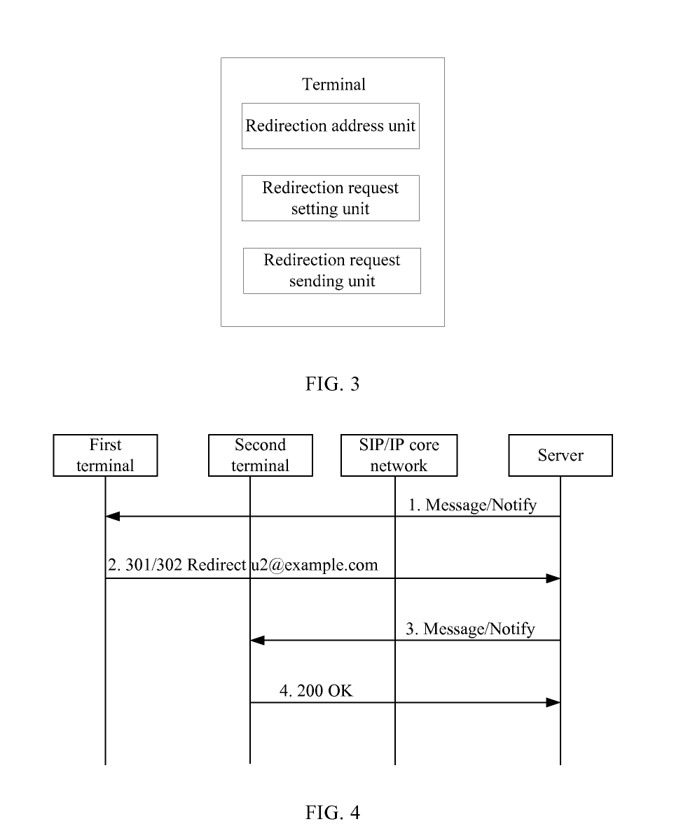

FIG. 3 is a schematic structural view of a terminal for implementing call direction according to the first embodiment of the present invention. Referring to FIG. 3, the terminal includes a redirection address unit, a redirection request setting unit, and a redirection request sending unit. The redirection address unit is adapted to store a redirection address. The redirection request setting unit is adapted to set a redirection request. The redirection request sending unit is adapted to send the redirection request through the SIP/IP core network.

When the terminal receives a PUSH message sent from the server through the SIP/IP core network, the redirection request sending unit sends a redirection request determined by the redirection request setting unit through the SIP/IP core network.

FIG. 4 is a signaling flow chart of a method for implementing call direction according to the first embodiment of the present invention. Referring to FIG. 4, when the server expects to send a message to a first terminal of the subscriber, the request reaches the first terminal through the SIP/IP core network. Unfortunately, the first terminal does not support the service, or the subscriber intends to receive the message by a second terminal, the first terminal returns 3xx redirection information to the server through the SIP/IP core network. The server sends the PUSH message to the address of the second terminal reported by the first terminal according to the redirection information reported by the first terminal. If the second terminal can receive the message, the second terminal returns a receive response to the server.

The detailed steps of the method for implementing call direction are given as follows.

(1) The server sends a PUSH message, for example, Message/Notify message, to a first terminal through the SIP/IP core network.

(2) If the subscriber of the first terminal expects the second terminal to receive the message, the first terminal sends the redirection request to the server. The redirection request carries a redirection address, and may further carry a redirection state code for determining a redirection time limit, for example, the redirection state code 301 or 302 represents a permanent redirection or a temporal redirection to the second terminal respectively. Furthermore, the address of the second terminal may be carried in a Contact Header field, so as notify the server that the expected redirection address is u2@example.com.

(3) After receiving the redirection request, the server sends the Message/Notify message again through the SIP/IP core network, and the address is changed to the address of the second terminal.

(4) After receiving the PUSH message, the second terminal returns a 200 OK message, and performs a normal process.

The Message/Notify message is an example of a SIP PUSH message, and the solution of the embodiment of the present invention is applicable to various SIP PUSH services with different realizing manners.

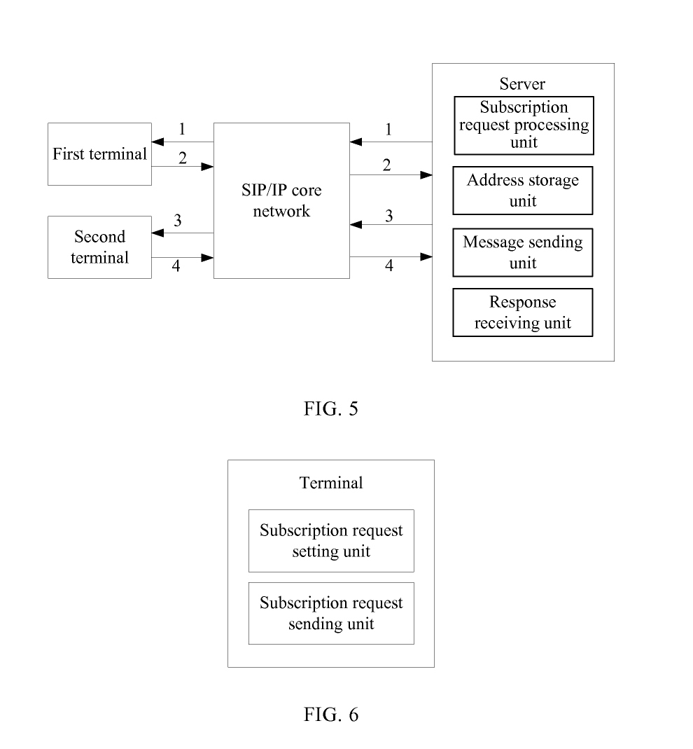

FIG. 5 is a schematic structural view of a system for implementing call direction according to a second embodiment of the present invention. Referring to FIG. 5, the system for implementing call direction includes a SIP/IP core network and a server. The SIP/IP core network is used for the transport of a SIP message, and the SIP message may include PUSH content, for example, PUSH OTA content. The server is adapted to transmit/receive messages through the SIP/IP core network, so as to communicate with a first terminal and other terminals.

The server is further adapted to receive a subscription request message carrying redirection information sent from the terminal, and send the PUSH message to a corresponding terminal according to address information of a redirection terminal carried in the subscription request message.

Referring to FIG. 5, in the embodiment of the system of the present invention, the server and the terminal may realize call redirection in the following manner.

(1) The first terminal sends a register or subscription request to the server through the SIP/IP core network, and the register or subscription request carries an address u2@example.com of a second terminal where the server is expected to send the message.

(2) The server receives the request, and returns a 200 OK message, and redirects a service message/all the messages sent to the first terminal to the address of the second terminal.

(3) When a service message sent to the first terminal reaches, the server sends the service message to the second terminal.

(4) The second terminal receives the message, returns a 200 OK message, and performs a normal process.

Referring to FIG. 5, in the embodiment of a server for implementing call direction according to the present invention, the server includes a subscription request processing unit, an address storage unit, and a message sending unit. The subscription request processing unit is adapted to receive the subscription request from the terminal and parse the address information of the redirection terminal from the subscription request. The address storage unit is adapted to store the address information of the redirection terminal. When the server needs to send the PUSH message to the terminal, the message sending unit sends the message to a corresponding terminal according to the address information of the redirection terminal. The server further includes a response receiving unit, adapted to receive a response from the terminal or the corresponding terminal through the core network.

FIG. 6 is a schematic structural view of a terminal for implementing call direction according to the second embodiment of the present invention. Referring to FIG. 6, the terminal includes a subscription request setting unit and a subscription request sending unit. The subscription request setting unit is adapted to generate a subscription request according to address information of a redirection terminal preset by the subscriber. The subscription request sending unit is adapted to send the subscription request.

The terminal generates the subscription request carrying the redirection information according to an input of the subscriber, and sends the subscription message to the server through the SIP/IP core network to subscribe for a redirection service. The subscription request carries the address information of the redirection terminal. The server receives the subscription request. When the server needs to send the PUSH message to the terminal, the server sends the message according to the address information of the redirection terminal.

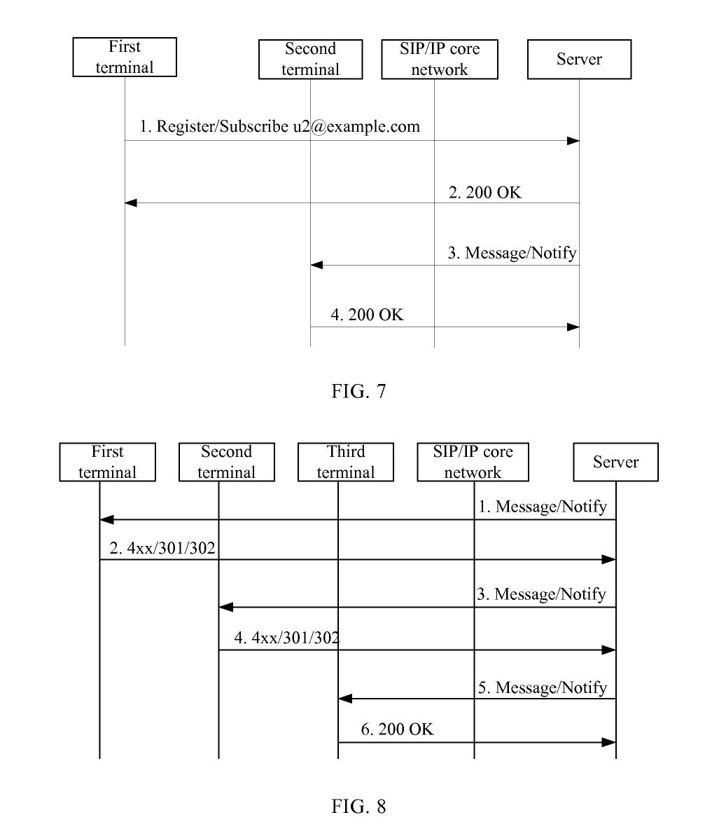

FIG. 7 is a flow chart of a redirection subscription signaling of a method for implementing call direction according to the second embodiment of the present invention. Referring to FIG. 7, before the server sends the service, if the subscriber expects the second terminal to receive the message received by the first terminal from the server, the first terminal actively sends the subscription request carrying the redirection information, for example, a POST message, to the sever, carries the address of the second terminal in the subscription request, and notifies the server that the second terminal is expected to receive all messages or one message. Then, the server receives the message and normally processes the service. When the message sent to the first terminal reaches, the server sends the message to the second terminal through the SIP/IP core network.

The redirection subscription steps in the method for implementing call direction are described as follows.

(1) The first terminal sends a register or subscription request to the server, and the register or subscription request carries the address u2@example.com of the second terminal where the server is expected to send the message.

(2) The server receives the request, and returns a 200 OK message, and a service message/all the messages sent to the first terminal is redirected to the address of the second terminal.

(3) When a service message sent to the first terminal reaches, the server sends the service message to the second terminal.

(4) The second terminal receives the message, returns a 200 OK message, and performs a normal process.

The Register/Subscribe message is an example of a SIP PUSH message, and the solution of the embodiment of the present invention is applicable to various SIP PUSH services with different realizing manners.

FIG. 8 is a flow chart of a first signaling of a method for implementing call direction according to a third embodiment of the present invention. Referring to FIG. 8, when a server sends a message to a first terminal, the first terminal rejects receiving the message or fails to receive the message due to the reason of timeout, a state indication is returned to the server to notify the server that the message sending operation fails, and the returned message does not carry address information. The server further attempts to send the message to a second terminal of the subscriber, and if the second terminal can receive the service, the second terminal returns a response to notify the server that the message is successfully received. If the second terminal does not support the service message, or is not expected to receive the service message, or fails to receive the message due to the reason of timeout, the second terminal returns a response to notify the server that the message sending operation fails. The server sends the message to a third terminal as a third attempt. If the third terminal can receive the message, the third terminal returns a response to notify the server that the message is successfully received.

The detailed steps of the method for implementing call direction are given as follows.

(1) The server sends a PUSH message, for example, a Message/Notify message, to the first terminal through the SIP/IP core network.

(2) The first terminal receives the message, prompts the server to redirect the message to other terminals, and sends a redirection request to the server. The redirection request carries a redirection message state code 301/302, but does not provide address information of a designated terminal. Alternatively, the first terminal is not expected to receive or cannot receive the message, and returns a 4xx state code to indicate to the server that the message sending operation fails.

(3) The server attempts to send the Message/Notify request to the second terminal according to address information registered by the terminal.

(4) The second terminal returns a message the same as that of the first terminal.

(5) The server attempts to send the Message/Notify request to the third terminal according to the address information registered by the terminal.

(6) The third terminal can receive the message, and returns a 200 OK state code.

Similarly, the above process is applicable to the situation that the server attempts to send the message to the second terminal and the third terminal at the same time when the server fails to send the message to the first terminal.

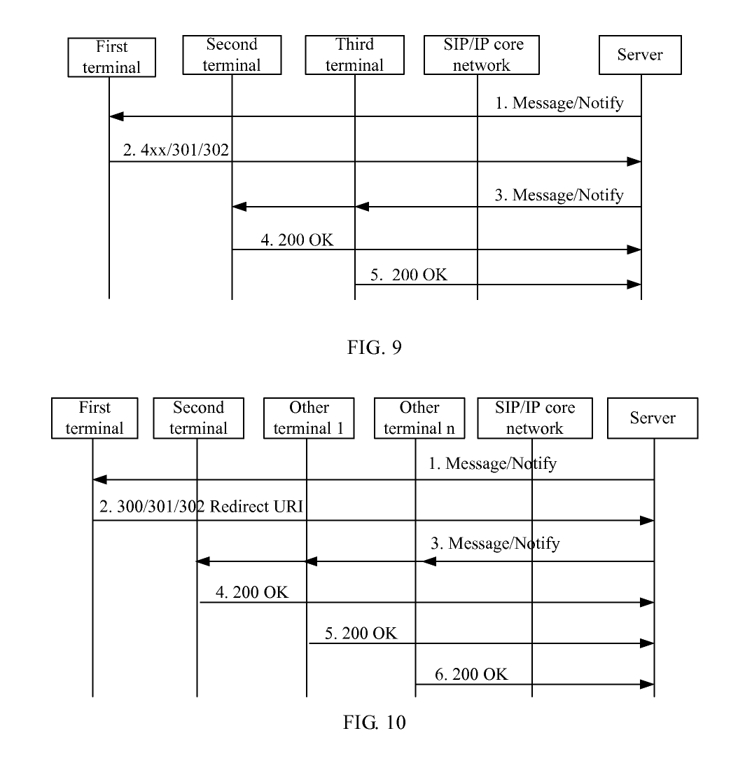

FIG. 9 is a second signaling flow chart of the method for implementing call direction according to the third embodiment of the present invention.

The detailed steps of the method for implementing call direction are given as follows.

(1) The server sends the Message/Notify message to the first terminal through the SIP/IP core network.

(2) The first terminal receives the message, prompts the server to redirect the message to other terminals, and returns a state code 301/302, but does not provide address information of a designated terminal. Alternatively, the first terminal is not expected to receive the message or cannot receive the message, and returns a 4xx state code to indicate to the server that the message sending operation fails.

(3) The server sends the Message/Notify request to an address registered by the terminal.

(4) If the second terminal can receive the message, the second terminal returns a 200 OK.

(5) If the third terminal can receive the message, the third terminal returns a 200 OK.

The Message/Notify message is an example of a SIP PUSH message, and the solution of the embodiment of the present invention is applicable to various SIP PUSH services with different realizing manners.

FIG. 10 is a signaling flow chart of a method for implementing call direction according to a fourth embodiment of the present invention. Referring to FIG. 10, when a server sends a message to a first terminal, if the subscriber of the first terminal expects that the message is redirected to other terminals, the first terminal carries a plurality of URI domain names in a state code 301/302 according to the URIs in a local storage list, and sends the URIs to the server. The server sends the message to each terminal according to the addresses, and each terminal returns receiving state information.

The detailed steps of the method for implementing call direction are given as follows.

(1) The server sends the Message/Notify request to the first terminal through the SIP/IP core network.

(2) If the subscriber of the first terminal expects the message to be sent to other terminals, the first terminal returns a redirection state code 300, 301, or 302, carries addresses of redirection terminals in a Contact Header field, and notifies the server that the address of each redirection terminal is one URI.

(3) The server sends the Message/Notify message to the address of each terminal in the list.

(4) The second terminal returns a receive response.

(5) Other terminal 1 returns a response.

(6) Other terminal n returns a response.

The Message/Notify message is an example of a SIP PUSH message, and the solution of the embodiment of the present invention is applicable to various SIP PUSH services with different realizing manners.

The core network according to the present invention is not limited to the SIP/IP core network, and may be a public land mobile-communication network (PLMN) core network, for example, a GSM core network, an IP multimedia subsystem (IMS), an IP network, and a SIP Push core network.

The state code of the redirection message in the embodiments of the present invention is an example for realizing the redirection message, and the solution of the embodiments of the present invention is applicable to various redirection services with different realizing manners.

In the call direction realized according to one or more embodiments of the present invention, if a subscriber has a plurality of terminals, when one of the terminals receives a service not supported by the terminal or through the configuration of the subscriber, the service can be permanently or temporally transferred to other terminals of the subscriber. In the embodiments of the present invention, the subscriber is enabled to select the terminal for receiving the service, thereby enhancing the subscriber's experience, and avoiding the wastes of network resources.

Through the descriptions of the above embodiments, those skilled in the art may clearly appreciate that the present invention may be realized through hardware or through combining software with a necessary universal hardware platform. Based on such understanding, the technical solution of the present invention may be realized in a form of a software product. The software product may be stored in a non-volatile storage medium, for example, a CD-ROM, a USB disk, or a mobile hard disk, which includes several instructions for enabling one computer device, for example, a personal computer, a server, or network equipment, to execute the method according to each embodiment of the present invention.

The above embodiments are merely intended to describe the technical solutions of the present invention, but not to limit the scope of present invention. It will be apparent to those skilled in the art that various modifications and variations can be made to the structure of the present invention without departing from the scope of the invention.

What is claimed is:

1. A method for implementing call directions, comprising:
sending a PUSH message to a terminal;
receiving a redirection request from the terminal; and
sending the PUSH message according to the redirection request.

2. The method according to claim 1, wherein the PUSH message is a session initiation protocol (SIP) message encapsulated by adopting a SIP protocol, and the PUSH message is sent through a SIP/Internet protocol (IP) core network.

3. The method according to claim 2, wherein the redirection request carries redirection address information; and
the process of sending the PUSH message according to the redirection request further comprises sending the PUSH message according to the redirection address information carried in the redirection request.

4. The method according to claim 2, wherein the process of sending the PUSH message according to the redirection request further comprises obtaining preset address information according to the redirection request, and sending the PUSH message according to the address information.

5. The method according to claim 3, wherein the redirection address information carries the addresses of one or more terminals, and the PUSH message is sent to the one or more terminals at the same time or one by one according to a designated sequence.

6. The method according to claim 4, wherein the redirection address information carries the addresses of one or more terminals, and the PUSH message is sent to the plurality of terminals at the same time or one by one according to a designated sequence.

7. The method according to claim 1, further comprising determining a redirection time limit according to a redirection code carried in the redirection request.

8. The method according to claim 1, further comprising receiving redirection success response information after sending the message through a SIP/IP core network according to the redirection request.

9. A method for implementing call direction, comprising:
receiving, by a server, a subscription request message from a first terminal, the subscription request carrying address information of a second terminal; and
sending, by the server, the PUSH message to the second terminal according to the address information when the server needs to send a PUSH message to the first terminal.

10. The method according to claim 9, further comprising returning, by the server, a subscription success response, after receiving the subscription request message from the first terminal.

11. The method according to claim 9, further comprising determining a redirection time limit according to a redirection code carried in the subscription request message, and storing the address information of the second terminal.

12. The method according to claim 9, further comprising receiving, by the server, a redirection request from the second terminal, and sending the PUSH message according to additional redirection address information carried in the redirection request.

13. The method according to claim 9, wherein the PUSH message is a session initiation protocol (SIP) message encapsulated by adopting a SIP protocol, and the PUSH message is sent through a SIP/Internet protocol (IP) core network.

14. A server for implementing call direction, comprising:
a message sending unit for sending a PUSH message through a SIP/Internet protocol (IP) core network;
a subscription request processing unit for receiving a redirection subscription request from a terminal, and parsing address information of a redirection terminal from the subscription request; and
an address storage unit for storing the address information of the redirection terminal,
wherein when the server needs to send the PUSH message to the terminal, the message sending unit sends the PUSH message according to the address information of the redirection terminal.

15. A server for implementing call direction, comprising:
a message sending unit for sending a PUSH message through a SIP/Internet protocol (IP) core network;
a redirection request processing unit for receiving and parsing the redirection request, and determining whether the redirection request carries address information of other terminals or not; and
an address unit for obtaining the address information of the corresponding redirection terminal according to a parsing result, wherein the message sending unit sends the PUSH message according to the address information of the redirection terminal.

16. The server according to claim 15, wherein the address unit further comprises:
an address information extracting unit for extracting the address information from the parsing result; and
an address storage unit for saving the address information of the redirection terminal,
wherein when the redirection request does not carry the address information, the address storage unit provides corresponding address information.

17. A terminal for implementing call direction, comprising:
a redirection address unit for storing address information of a redirection terminal; and
a redirection request setting unit for setting a redirection request, wherein the redirection request carries address information of the redirection terminal; and
a redirection request sending unit for sending the redirection request through a SIP/Internet protocol (IP) core network.

18. A terminal for implementing call direction, comprising:
a subscription request setting unit for generating a subscription request according to address information of a redirection terminal set by a subscriber; and
a subscription request sending unit for sending the subscription request through a SIP/Internet protocol (IP) core network.
